(19) United States
(12) Patent Application Publication
(10) Pub. No.: US 2009/0119077 A1
(43) Pub. Date: May 7, 2009

(54) Use of simulation to generate predictions pertaining to a manufacturing facility

(76) Inventors: David Everton Norman, Bountiful, UT (US); Richard Stafford, Bountiful, UT (US)

Correspondence Address: APPLIED MATERIALS/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/983,120

(22) Filed: Nov. 6, 2007

(51) Int. Cl. G06G 7/48

(52) U.S. Cl. 703/6

(57) ABSTRACT

In one embodiment, a method for using simulation to predict the future of a manufacturing facility includes obtaining data pertaining to the current state of the manufacturing facility, and building a simulation model based on the obtained data. The method may further include identifying a time horizon defining a point of time in the future, performing a simulation run for the time horizon using the simulation model to predict the state of the manufacturing facility at the future point of time, and storing the resulting predictions in a database.

### FIELD OF THE INVENTION

Embodiments of the present invention relate generally to managing a manufacturing facility, and more particularly to the use of simulation to generate predictions pertaining to a manufacturing facility.

### BACKGROUND OF THE INVENTION

In an industrial manufacturing environment, accurate control of the manufacturing process is important. Ineffective process control can lead to manufacture of products that fail to meet desired yield and quality levels, and can significantly increase costs due to increased raw material usage, labor costs and the like.

When managing a manufacturing facility, complicated decisions need to be made about what an idle equipment should process next. For example, a user may need to know whether a high-priority lot will become available in the next few minutes. Current Computer Integrated Manufacturing (CIM) systems only provide information about the current state of the facility to aid in making those decisions. Information about what the facility might look like in the future is not immediately available and calculating it on the fly is expensive. This limits the sophistication of decisions that can be made by the CIM system. In particular, producing a schedule for the facility requires this sort of predictive information and calculating it can be a significant portion of the cost of producing a schedule.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a prediction server.

FIG. 2 illustrates an exemplary schema of a simulation model, in accordance with one embodiment of the invention.

FIG. 3 is a flow diagram of one embodiment of a method for using simulation to generate predictions pertaining to a manufacturing facility.

FIG. 4 illustrates an exemplary output of a simulation engine, in accordance with one embodiment of the invention.

FIG. 5 illustrates an exemplary network architecture in which embodiments of the invention may operate.

FIG. 6 illustrates a diagrammatic representation of a machine in the exemplary form of a computer system, in accordance with one embodiment of the present invention

### DETAILED DESCRIPTION OF THE INVENTION

Methods and systems for using simulation to provide predictions pertaining to a manufacturing facility are discussed. In one embodiment, a prediction system includes a simulation model builder and a simulation engine. The simulation model builder may be responsible for obtaining data pertaining to the current state of the manufacturing facility, and building a simulation model using the obtained data. The simulation engine may be responsible for identifying a time horizon, and performing a simulation run for the time horizon using the simulation model. The simulation run may be performed to predict the state of the manufacturing facility at a specific point of time in the future that is defined by the time horizon. The simulation engine may store the resulting predictions in a commercial or custom database or in application or system memory, which can subsequently be accessed to provide predictions to a requester.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes a machine readable storage medium (e.g., read only memory (“ROM”), random access memory (“RAM”), magnetic disk storage media, optical storage media, flash memory devices, etc.), a machine readable transmission medium (electrical, optical, acoustical or other form of propagated signals (e.g., carrier waves, infrared signals, digital signals, etc.)), etc.

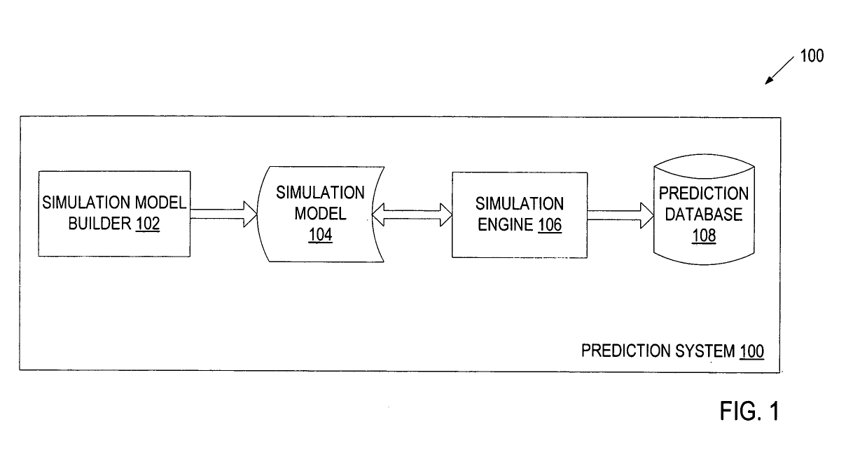

FIG. 1 is a block diagram of one embodiment of a prediction system 100. The prediction system 100 uses simulation to predict the future of a manufacturing facility (e.g., a semiconductor fabrication facility) or some of its components. While the functionality of the prediction system 100 is described with respect to the entire manufacturing facility, one of ordinary skill in the art will understand that the same functionality can easily be provided for a single component or several components of the manufacturing facility (e.g., only for a manufacturing execution system (MES) in the manufacturing facility or for a subset of the equipment in the industrial manufacturing facility).

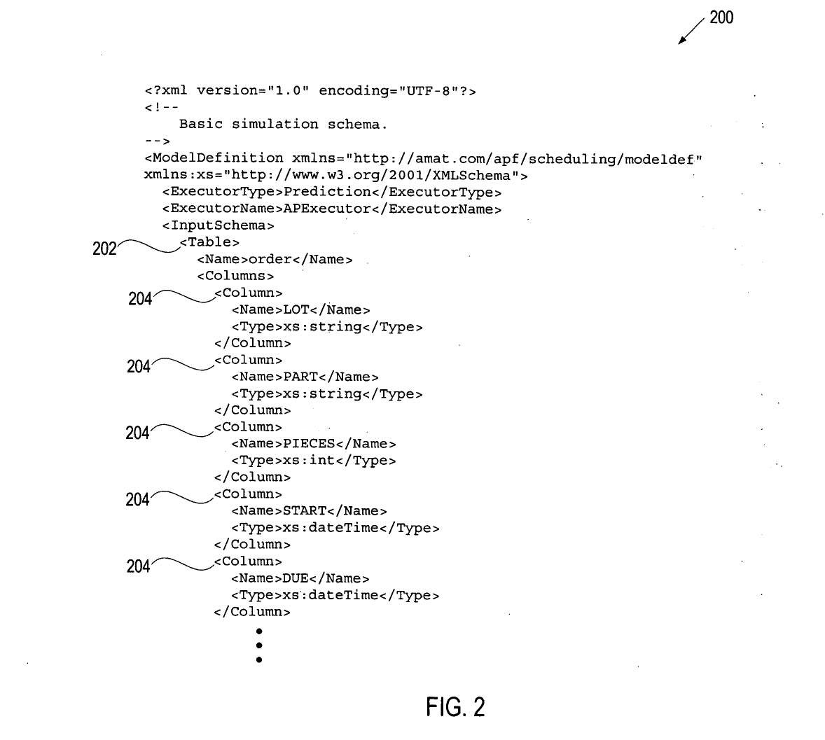

The prediction system 100 may include a simulation model builder 102, a simulation engine 106, and a prediction database 108. The simulation model builder 102 is responsible for building a simulation model 104. The simulation model 104 defines dynamic and static data pertaining to the manufacturing facility. The dynamic data may specify the state of the manufacturing facility, including, for example, the state of the equipment, current processing steps of product items (e.g., wafer lots), composition of product, quantity of product, etc. The static data may reflect the expected behavior of equipment, including its capacity, maintenance characteristics, applicable type of product, sequence of process steps for a given product type, etc. An exemplary schema of a simulation model will be discussed in more detail below in conjunction with FIG. 2.

Referring to FIG. 1, the simulation model builder 102 collects static data and current dynamic data pertaining to the manufacturing facility and initializes the simulation model 104 with the collected data. The simulation model builder 102 may collect the current dynamic data by submitting data queries to source system(s) such as a manufacturing execution system (MES), a maintenance management system (MMS), a material control system (MCS), an equipment control system (ECS), an inventory control system (ICS), computer integrated manufacturing (CIM) systems, various databases (including but not limited to flat-file storage systems such as Excel files), etc. The static data may be collected by accessing centralized data repositories of the manufacturing facility or by querying the above source systems. The static data may need only be collected once and may be stored in a local store (not shown) maintained by the prediction system 100 for use in subsequent simulation runs.

The simulation engine 106 runs simulation based on the simulation model 104. In particular, the simulation engine 106 uses the data stored in the simulation model 104 to simulate the operation of the manufacturing facility step by step, synchronized in time, until reaching a specific point in the future (e.g., based on a time horizon provided by the user). For example, the simulation engine 106 may simulate processing of different lots of wafers specified in the simulation model 104 based on static data included in the simulation model (e.g., how long it takes for specific pieces of equipment to process a lot, the capacity of the specific pieces of equipment to process multiple lots at the same time, etc.).

The simulation engine 106 records each transition of the product and the equipment, operators, tools or other resources during a simulation run. For example, the simulation engine 106 records each predicted processing step the product goes through and each predicted state (e.g., active, idle, down-time, etc.) the equipment, operators, tools or other resources go through during simulation of the operation of the manufacturing facility. The simulation engine 106 records the resulting predictions in the prediction database 108. The prediction database 108 may represent any type of data storage including, for example, relational or hierarchical databases, flat files, application or shared memory, etc. Subsequently, the prediction database 108 may be accessed to provide predictions to requestors. The requestors may include authorized users and/or systems of the manufacturing facility such as MES, MMS, MCS, ECS, ICS, CIM systems, scheduler, dispatcher, etc.

In one embodiment, the prediction system 100 provides a user interface (UI) allowing a user to specify desired simulation parameters. For example, the UI may allow a user to enter a time horizon (a point of time in the future for which simulation should run). The user may also specify source systems to which data queries should be submitted, and characteristics of the data queries (e.g., parameters, filters, etc.). In addition, the user may identify entities for which prediction should be generated (e.g., equipment, product, operators, resources, etc.), and specify a trigger for initiating simulation (e.g., an event, a scheduled time or user request).

FIG. 2 illustrates a data schema 200 of an exemplary simulation model, in accordance with one embodiment of the invention. The data schema 200 may be an XML schema or any other type of schema. The data schema 400 defines multiple tables 202 having various columns 204 to capture dynamic and static data needed for simulation.

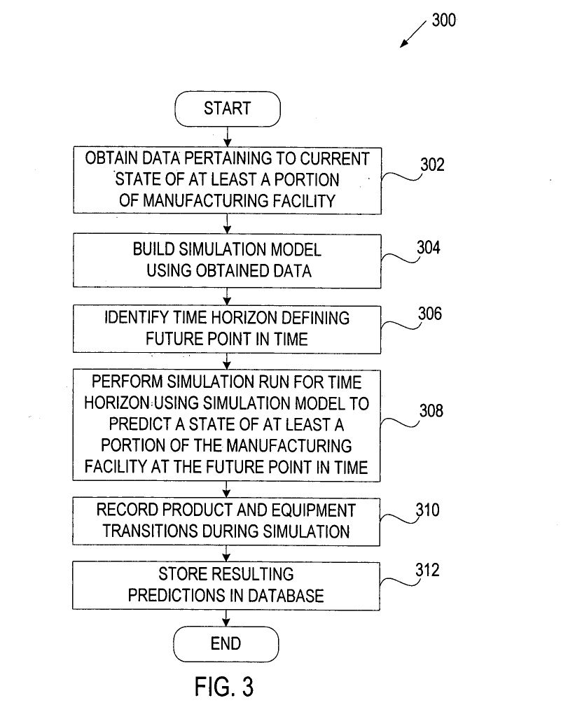

FIG. 3 is a flow diagram of one embodiment of a method 300 for using simulation to generate predictions pertaining to a manufacturing facility. The method may be performed by processing logic that may comprise hardware (e.g., circuitry, dedicated logic, etc.), software (such as run on a general purpose computer system or a dedicated machine), or a combination of both. In one embodiment, processing logic resides in a prediction system 100 of FIG. 1.

Referring to FIG. 3, processing logic begins with obtaining data pertaining to the current state of the manufacturing facility or its components (block 302). Processing logic may obtain dynamic data by submitting queries to source systems for information required by a simulation model, and receiving query results from the source systems. In one embodiment, the queries are created on the fly. Alternatively, the queries are predetermined for each source system used to collect data. The queries may be specified by a user or be created automatically based on information needed by the simulation model. In one embodiment, processing logic also obtains static data (e.g., data reflecting expected behavior of equipment, equipment capacity, maintenance characteristics and applicable type of product, etc.). The static data may be collected by querying the source systems or retrieving previously collected static data from a local store.

At block 304, processing logic builds the simulation model using the obtained data. In particular, in one embodiment, processing logic initializes the simulation model with dynamic data (e.g., the current state of the manufacturing facility) and static data (e.g., expected behavior of equipment, equipment capacity, maintenance characteristics and applicable type of product, etc).

At block 306, processing logic identifies a time horizon that defines a point of time in the future for which predictions should be generated. The time horizon may be predetermined or be specified by a user.

At block 308, processing logic performs a simulation run for the time horizon using the simulation model. Processing logic may perform the simulation run by modeling the processing behavior of the equipment step by step until reaching a point defined by the time horizon.

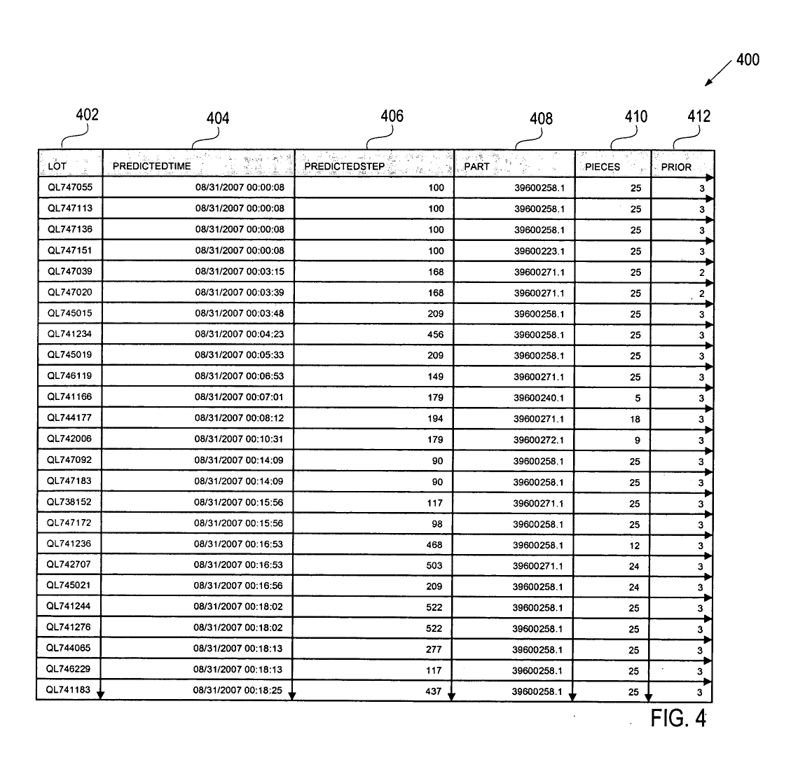

At block 310, processing logic records each transition of the product and the equipment, operators, tools or other resources during the simulation run. For example, processing logic records each predicted processing step the product goes through and each predicted state the equipment, operators, tools or other resources go through when the operation of the manufacturing facility is being simulated. A portion of an exemplary output of the simulation engine will be discussed in more detail below in conjunction with FIG. 4.

At block 312, processing logic records the resulting predictions in a prediction database (e.g., any type of data storage including, for example, a relational or hierarchical database, flat files, application or shared memory, etc.). The prediction database may subsequently be accessed to provide predictions to requesters (e.g., subscribers of prediction services or any other qualified recipients of prediction information).

FIG. 4 illustrates an exemplary output 400 of a simulation engine, in accordance with one embodiment of the invention. The output 400 specifies lots 402 processed during the simulation run, processing steps 406 through which the lots 402 go through at a certain time 404. In addition, the output 400 specifies parts of equipment 408 that process lots 402, and the number of items 410 contained in each lot 402. Column 412 specifies,the material priority.

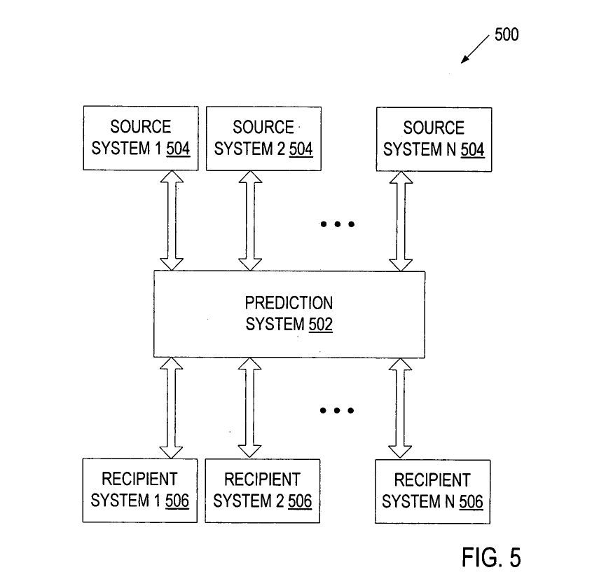

FIG. 5 illustrates an exemplary network architecture 500 in which embodiments of the present invention may operate. The network architecture 500 may represent a manufacturing facility (e.g., a semiconductor fabrication facility) and may include a prediction system 502, a set of source systems 504 and a set of recipient systems 506. The prediction system 502 may communicate with the source systems 504 and the recipient systems 506 via a network. The network may be a public network (e.g., Internet) or a private network (e.g., local area network (LAN)).

The source systems 504 may include, for example, MES, MMS, MCS, ECS, ICS, CIM systems, or various databases or repositories in the manufacturing facility. The recipient systems 506 may include some or all of the source systems 104, as well as some other systems such as a scheduler, a dispatcher, etc. The prediction system 502 may be hosted by one or more computers with one or more internal or external storage devices.

The prediction system 502 uses simulation to build predictions about the future of the manufacturing facility and its components. The prediction system 502 builds predictions by collecting data from the source systems 504, running simulation using the collected data to generate predictions, and providing the predictions to the recipient system 506. The predictions generated by the prediction system 502 may specify, for example, a future state of the equipment in the manufacturing facility, the quantity and composition of the product that will be manufactured in the facility, the number of operators needed by the facility to manufacture this product, the estimated time a product will finish a given process operation and/or be available for processing at a given step, the estimated time a preventative maintenance operation should be performed on an equipment, etc.

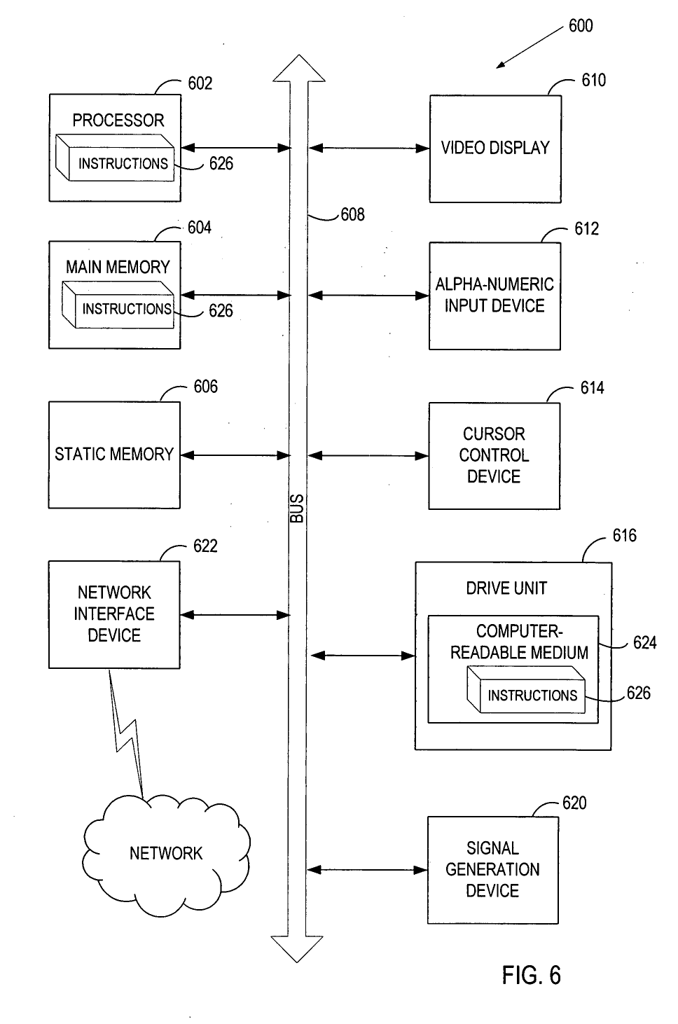

FIG. 6 illustrates a diagrammatic representation of a machine in the exemplary form of a computer system 600 within which a set of instructions, for causing the machine to perform any one or more of the methodologies discussed herein, may be executed. The machine may be connected (e.g., networked) to other machines in a LAN, an intranet, an extranet, or the Internet. The machine may operate in a client-server network environment, or as a peer machine in a peer-to-peer (or distributed) network environment. While only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device (processor) 602, a main memory 604 (e.g., read-only memory (ROM), flash memory, dynamic random access memory (DRAM) such as synchronous DRAM (SDRAM) or Rambus DRAM (RDRAM), etc.), and a static memory 606 (e.g., flash memory, static random access memory (SRAM), etc.), which may communicate with each other via a bus 630. Alternatively, the processing device 602 may be connected to memory 604 and/or 606 directly or via some other connectivity means.

Processing device 602 represents one or more general-purpose processing devices such as a microprocessor, central processing unit, or the like. More particularly, the processing device 602 may be complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 602 is configured to execute processing logic 626 for performing the operations and steps discussed herein.

The computer system 600 may further include a network interface device 608 and/or a signal generation device 616. It also may or may not include a video display unit (e.g., a liquid crystal display (LCD) or a cathode ray tube (CRT)), an alphanumeric input device (e.g., a keyboard), and/or a cursor control device(e.g., a mouse).

The computer system 600 may or may not include a secondary memory 618 (e.g., a data storage device) having a machine-accessible storage medium 631 on which is stored one or more sets of instructions (e.g., software 622) embodying any one or more of the methodologies or functions described herein. The software 622 may also reside, completely or at least partially, within the main memory 604 and/or within the processing device 602 during execution thereof by the computer system 600, the main memory 604 and the processing device 602 also constituting machine-accessible storage media. The software 622 may further be transmitted or received over a network 620 via the network interface device 608.

While the machine-accessible storage medium 631 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical and magnetic media, and carrier wave signals.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A computerized method comprising:
obtaining data pertaining to a current state of at least a portion of a manufacturing facility;
building a simulation model based on the data pertaining to the current state of at least a portion of the manufacturing facility;
identifying a time horizon defining a point of time in the future;
performing a simulation run for the time horizon using the simulation model to predict a state of at least a portion of the manufacturing facility at the future point of time; and
storing resulting predictions in a database

2. The method of claim 1 wherein the data pertaining to the current state of at least a portion of the manufacturing facility is obtained from at least one of a manufacturing execution system (MES), a maintenance management system (MMS), a material control system (MCS), an equipment control system (ECS), a computerized integrated manufacturing system (CIM), or an inventory control system (ICS).

3. The method of claim 1 wherein the data pertaining to the current state of at least a portion of the manufacturing facility comprises a current state of equipment in at least a portion of the manufacturing facility and a current processing step of a product in at least a portion of the manufacturing facility.

4. The method of claim 1 wherein obtaining the data pertaining to the current state of at least a portion of the manufacturing facility comprises:
submitting queries to one or more source system to obtain data needed for the simulation model; and
receiving query results from the source systems.

5. The method of claim 1 further comprising:
obtaining static data describing static characteristics of at least a portion of the manufacturing facility; and
adding the static data to the simulation model.

6. The method of claim 1 wherein the static characteristics of at least a portion of the manufacturing facility comprise information about the behavior of equipment, operators or tools in at least a portion of the manufacturing facility.

7. The method of claim 1 wherein performing the simulation run comprises:
recording transitions of a product during the simulation run; and
recording transitions of equipment, operators or tools during the simulation run.

8. The method of claim 7 wherein:
the recorded transitions of the product identify each step the product goes through during the simulation run; and
the recorded transitions of the equipment, operators or tools identify each state the equipment, operators or tools go through during the simulation run.

9. The method of claim 4 further comprising:
receiving simulation properties from a user, the prediction properties identifying at least one of the time horizon, the one or more source systems, query parameters, or entities being predicted.

10. A computer-readable medium having executable instructions to cause a computer system to perform a method comprising:
obtaining data pertaining to a current state of at least a portion of a manufacturing facility;
building a simulation model based on the data pertaining to the current state of at least a portion of the manufacturing facility;
identifying a time horizon defining a point of time in the future;
performing a simulation run for the time horizon using the simulation model to predict a state of at least a portion of the manufacturing facility at the future point of time; and
storing resulting predictions in a database.

11. The computer-readable medium of claim 10 wherein the data pertaining to the current state of at least a portion of the manufacturing facility is obtained from at least one of a manufacturing execution system (MES), a maintenance management system (MMS), a material control system (MCS), an equipment control system (ECS), a computer integrated manufacturing system (CIM), or an inventory control system (ICS).

12. The computer-readable medium of claim 10 wherein the data pertaining to the current state of at least a portion of the manufacturing facility is dynamic data comprising a current state of equipment, operators or tools in at least a portion of the manufacturing facility and a current processing step of a product in at least a portion of the manufacturing facility.

13. The computer-readable medium of claim 10 wherein obtaining the data pertaining to the current state of at least a portion of the manufacturing facility comprises:
submitting queries to one or more source system to obtain data needed for the simulation model; and
receiving query results from the source systems.

14. The computer-readable medium of claim 10 wherein the method further comprises:
obtaining static data describing static characteristics of at least a portion of the manufacturing facility; and
adding the static data to the simulation model.

15. The computer-readable medium of claim 10 wherein performing the simulation run comprises:
recording transitions of a product during the simulation run; and
recording transitions of equipment, operators or tools during the simulation run.

16. The computer-readable medium of claim 15 wherein:
the recorded transitions of the product identify each step the product goes through during the simulation run; and
the recorded transitions of the equipment, operators or tools identify each state the equipment, operators or tools go through during the simulation run.

17. An apparatus comprising:
a simulation model builder to obtain data pertaining to a current state of at least a portion of a manufacturing facility, and to build a simulation model based on the data pertaining to the current state of at least a portion of the manufacturing facility; and
a simulation engine, coupled to the simulation model builder, to identify a time horizon defining a point of time in the future, and to perform a simulation run for the time horizon using the simulation model to predict a state of at least a portion of the manufacturing facility at the future point of time; and
a prediction database, coupled to the simulation engine, to store predictions resulting from the simulation run.

18. The apparatus of claim 17 wherein the data pertaining to the current state of at least a portion of the manufacturing facility is obtained from at least one of a manufacturing execution system (MES), a maintenance management system (MMS), a material control system (MCS), an equipment control system (ECS), a computer integrated manufacturing system (CIM), or an inventory control system (ICS).

19. The apparatus of claim 17 wherein the data pertaining to the current state of at least a portion of the manufacturing facility comprises a current state of equipment, operators or tools in at least a portion of the manufacturing facility and a current processing step of a product in at least a portion of the manufacturing facility.

20. The apparatus of claim 17 wherein the simulation model builder is to obtain the data pertaining to the current state of at least a portion of the manufacturing facility by
submitting queries to one or more source system to obtain data needed for the simulation model, and
receiving query results from the source systems.

21. The apparatus of claim 17 wherein the simulation model builder is further to obtain static data describing static characteristics of at least a portion of the manufacturing facility, and to add the static data to the simulation model.

22. The apparatus of claim 17 wherein the simulation engine is to record transitions of a product during the simulation run, and to record transitions of equipment, operators or tools during the simulation run, wherein the recorded transitions of the product identify each step the product goes through during the simulation run, and the recorded transitions of the equipment, operators or tools identify each state the equipment, operators or tools go through during the simulation run.
